(19) United States
(12) Patent Application Publication
(10) Pub. No.: US 2004/0048109 A1
(43) Pub. Date: Mar. 11, 2004

(54) Penetration resistant article

(75) Inventors: Kaj Granqvist, Taby (SE); Anders Ortegren, Uppsala (SE); Gerry Castenback, Bromma (SE)

Correspondence Address: YOUNG & THOMPSON, 745 SOUTH 23RD STREET 2ND FLOOR, ARLINGTON, VA, 22202

(73) Assignee: SAFEBOARD AB, STOCKHOLM (SE)

(21) Appl. No.: 10/266,747

(22) Filed: Oct. 9, 2002

Related U.S. Application Data
(63) Continuation-in-part of application No. 10/234,384, filed on Sep. 5, 2002.

(51) Int. Cl. B32B 3/30

(52) U.S. Cl. 428/911; 442/203; 442/208

(57) ABSTRACT

A penetration resistant article consisting essentially of one or more layers of a woven fabric made from a yarn of polyester, polyamide, polypropylene, polyethylene, or derivatives or mixtures thereof having a friction raising characteristic.

The present invention relates to a penetration resistant article, which protects from penetration, such as stabs or thrusts from sharp instruments such as ice picks.

### TECHNICAL BACKGROUND

There has long been a need for protective garments exhibiting improved penetration resistance from sharp pointed implements. However, attention has been directed primarily toward ballistics and toward garments, which provide protection from ballistics threats.

International Publication No. WO 93/00564, published Jan. 7, 1993, discloses ballistic structures using layers of fabric woven from high tenacity para-aramid yarn.

Attempts have been made to provide both puncture resistance and ballistic resistance. Thus, U.S. Pat. No. 5,472,769 describes a combination of knitted aramid yarn layers and deflection layers of materials such as metal wire. European Patent Application No. 670,466 describes a ballistic and stab-resistant system wherein the knife stab resistance is imparted by embedding chainmail in a polymer resin.

Structures for protection from both ice pick and knife penetration and ballistic threats are disclosed in U.S. Pat. No. 6,133,169. They are composed of flexible metallic based structures, tightly-woven fabric layers, and ballistic layers, all arranged such that the tightly-woven fabrics layers are nearer than the ballistic layers to the threat strike face of the structure.

In U.S. Pat. No. 5,677,029 a flexible article is described, which comprises two or more layers, at least one of said layers being a fibrous layer, and at least one of said layers being a polymeric layer in contact with and bound to all or portion of said fibrous layer. It is especially ballistic resistant but also penetration resistant to both ice pick and knife.

Under certain circumstances, where knifes and gun may be excluded, e.g. in jails, there is still a need for protection against sharp instruments such as ice picks, which may be made from in house material, such as forks, spoons or table knives.

U.S. Pat. No. 5,578,358 discloses aramid articles having improved resistance to penetration by sharp implements. Kevlar, poly(p-phenylene terephthalamide), is preferred. The articles are woven with tough, low denier, aramid yarns in a tight plain weave configuration; and, when used in several layers, the layers are not stitched together.

### SUMMARY OF THE INVENTION

The invention relates to a penetration resistant article consisting essentially of one or more layers of a fabric made from a yarn of polyester, polyamide, polypropylene, polyethylene, or derivatives or mixtures thereof and having a friction raising means.

The articles according to the invention are advantageous in that they are lower in cost than protective articles heretofore made of Kevlar construction and they also exhibit favourable resistance to penetration from sharp instruments such as ice picks, needles, cannulas etc. Moreover, the articles are not sensitive to UV light in that they keep their characteristics unaffected. They are also flame resistant. When tested according to NIJ Standard 0115.00 the ice pick even get stuck in the fabric, which shows the very firm resistance in the fabric.

### DETAILED DESCRIPTION OF THE INVENTION

The invention relates to a penetration resistant article consisting essentially of one or more layers of a woven fabric made from a yarn of polyester, polyamide, polypropylene, polyethylene, or derivatives thereof and having a friction raising means. Preferably the article is less penetrated than 7 mm at 24 joules and less than 20 mm at 36 joules when tested according to NIJ Standard 0115.00.

One or more layers of the fabric may be included in the article. The layers may be joined at the edges of the article and otherwise substantially be free from means for holding the layers of fabric together. Preferably 5-30, especially 10-25 layers may be used such as 14-22 layers.

A single layer of the woven article of this invention may provide a measure of penetration resistance and, therefore, a degree of protection; but a plurality of layers are usually used in a finished product. It is in the use of a plurality of layers that the present invention exhibits its most pronounced and surprising improvement. The inventors herein have discovered that articles of this invention, when placed together in a plurality of layers afford a surprisingly effective penetration resistance when the articles are not tightened to one another so as to permit relative movement between adjacent layers. Adjacent layers or articles may be fastened e.g. at the edges e.g. with glue or tape. There may also be some loose interlayer connections at relatively great spacings compared with the thickness of the articles. The layers may also be put into a bag of fabric.

The number of layers depends on the material chosen the thickness of the yarn and the tightness of the fabric and has to be tested in each case. Generally there may be at least 10 layers, preferably at least 15 layers. Between 14 and 22 layers and especially between 16 and 20 layers has turned out well. It has turned out that 16 layers of a fabric made from a polyamide 66 yarn produced by Acordis according to Example 1 fulfils the NIJ standard 0115.00 when tested at 24 joule.

The linear density of a yarn is determined by weighing a known length of the yarn. “dTex” is defined as the weight, in grams, of 10,000 meters of the yarn. The plurality of tightly woven fabric layers are made from yarns of high tenacity yarn, wherein the yarns generally have a linear density of less than 1800 dTex, preferably less than 1000 dTex and especially less than 800 dTex.

The yarns used in this invention have preferably a high tenacity combined with a high elongation at break to yield a high tensile strength. The tenacity should be at least 65 cN/dTex, and there is no known upper limit for tenacity. Below about 65 cN/dTex the yarn doesn't exhibit adequate strength for meaningful protection. The elongation to break should be at least 3.0 percent and there are no known upper limits for elongation. Elongation to break, which is less than 3.0 percent results in a yarn, which is brittle and yields a toughness, which is less than necessary for the protection, sought herein.

“Tensile strength” is a measure of the energy absorbing capability of a yarn up to its point of failure in tensile stress/strain testing. Tensile strength is sometimes, also, known as “Energy to Break”. Tensile strength or Energy to Break is a combination of tenacity and elongation to break and is represented by the area under the stress/strain curve from zero strain to break.

The yarn has preferably 15-250 filaments in warp and weft. Examples of number of filaments used in warp and weft are 36 and 60-160, such as 136-144 and 140 in warp and weft. There may be different numbers or the same numbers of filaments in warp and weft, preferably the same number.

The closeness of the fabric is around 10-60 threads/cm in he warp and 10-60 threads/cm in the weft, especially 15-40, preferably 19-35 threads/cm in the warp and 19-35 threads/cm in the weft, e.g. 27 threads/cm in the warp and 27 threads/cm in the weft. The closeness may be different or the same in warp and weft, preferably the same.

The yarn of the fabric that is used in the article according to the invention may be produced from the following compounds.

Aliphatic, cycloaliphatic and aromatic polyesters may be used such as poly(1,4-cyclohexlidene dimethyl eneterephathalate) cis and trans, poly(ethylene-1,5-naphthalate), poly(ethylene-2,6-naphthalate), poly(1,4-cyclohexane dimethylene terephthalate) (trans), poly(decamethylene terephthalate), poly(ethylene terephthalate), poly(ethylene isophthalate), poly(ethylene oxybenozoate), poly(para-hydroxy benzoate), poly(dimethylpropiolactone), poly(decamethylene adipate), poly(ethylene succinate), poly(ethylene azelate), poly(decamethylene sebacate), poly(β,β-dimethyl-propiolactone), and the like.

Polyesters may be used according to the invention, such as those of the compositions include poly(oxy-trans-1,4-cyclohexyleneoxycarbonyl-trans-1,4-cyclohexylenecarbony 1-β-oxy-1,4-phenyl-eneoxyterephthaloyl) and poly(oxy-cis-1,4-cyclohexyleneoxycarbonyl-trans-1,4-cyclohexylenecarbonyl-β-oxy-1,4-phenyleneoxyterephthaloyl) in methylene chloride-o-cresol poly[(oxy-trans-1,4-cyclohexylene-oxycarbonyl-trans-1,4-cyclohexylenecarbonyl-β-oxy-(2-methyl-1,4-phenylene)oxy-terephthaloyl)] in 1,1,2,2-tetrachloroethane-o-chlorophenol-phenol (60:25:15 vol/vol/vol), poly[oxy-trans-1,4-cyclohexyleneoxycarbonyl-trans-1,4-cyclohexylenecarbony 1-β-oxy(2-methyl-1,3-phenylene)oxy-terephthaloyl] in o-chlorophenol and the like; Thermotropic copolyesters may also be used as for example copolymers of 6-hydroxy-2-naphthoic acid and p-hydroxy benzoic acid, copolymers of 6-hydroxy-2-naphthoic acid, terephthalic acid and p-amino phenol, copolymers of 6-hydroxy-2-naphthoic acid, terephthalic acid and hydroquinone, copolymers of 6-hydoroxy-2-naphtoic acid, p-hydroxy benzoic acid, hydroquinone and terephthalic acid, copolymers of 2,6-naphthalene dicarboxylic acid, terephthalic acid, isophthalic acid and hydroquinone, copolymers of 2,6-naphthalene dicarboxylic acid and terephthalic acid, copolymers of p-hydroxybenzoic acid, terephthalic acid and 4,4′-dihydoxydiphenyl, copolymers of p-hydroxybenzoic acid, terephthalic acid, isophthalic acid and 4,4′-dihydroxydiphenyl, p-hydroxybenzoic acid, isophthalic acid, hydroquinone and 4,4′-dihydroxybenzophenone, copolymers of phenyl-terephthalic acid and hydroquinone, copolymers of chlorohydroquinone, terephthalic acid and p-acetoxy cinnamic acid, copolymers of chlorohydroquinone, terephthalic acid and ethylene dioxy-4,4′-dibenzoic acid, copolymers of hydroquinone, methylhydroquinone, p-hydroxybenzoic acid and isophthalic acid, copolymers of (1-phenylethyl)hydroquinone, terephthalic acid and hydroquinone, and copolymers of poly(ethylene terephthalate) and p-hydroxybenzoic acid; and thermotropic polyamides and thermotropic copoly(amide-esters).

Other suitable polyesters may be poly(ethylene azelate), poly(ethylene-1,5-naphthalate), poly(1,4-cyclohexane dimethylene terephthalate), poly(ethylene oxybenzoate) (A-Tell), poly(para-hydroxy benzoate) (Ekonol), poly(1,4-cyclohexylidene dimethylene terephthalate) (Kodel)(as), poly(1,4-cyclohexylidene dimethylene terephthalate) (Kodel) (trans), polyethylene terephthalate, polybutylene terephthalate and the like.

Aliphatic and cycloaliphatic polyamides may also be used according to the invention, such as the copolyamide of 30% hexamethylene diammonium isophthalate and 70% hexamethylene diammonium adipate, the copolyamide of up to 30% bis-(-amidocyclohexyl) methylene, terephthalic acid and caprolactam, polyhexamethylene adipamide (polyamide 66), poly(butyrolactam) (polyamide 4), poly (9-aminonoanoic acid), polyamide 46 poly(tetra-methylene-adipaide), (polyamide 9), poly(enantholactam) (polyamide7), poly(capryllactam) (polyamide 8), polycaprolactam (polyamide 6), poly(p-phenylene terephthalamide), polyhexamethylene sebacamide (polyamide 6,10), polyaminoundecanamide (polyamide 11), polydodeconolactam (polyamide 12), polyhexamethylene isophthalamide, polyhexamethylene terephthalamide, polycaproamide, poly(nonamethylene azelamide) (polyamide 9,9), poly(decamethylene azelamide) (polyamide 10,9), poly(decamethylene sebacamide) (polyamid 10,10), poly>bis-(4-aminocyclothexyl)methane 1,10-decanedicarboxamide (Qiana) (trans), or combination thereof; Polyamide 66 is preferred.

Fabrics of the present invention may be made from yarns of aramid fibres. By “aramid” is meant a polyamide wherein at least 85% of the amide (—CO—NH—) linkages are attached directly to two aromatic rings. Suitable aramid fibres are described in Man-Made Fibres—Science and Technology, Volume 2, Section titled Fibre-Forming Aromatic Polyamides, page 297, W. Black et al., Interscience Publishers, 1968. Aramid fibres are, also, disclosed in U.S. Pat. Nos. 4,172,938; 3,869,429; 3,819,587; 3,673,143; 3,354,127; and 3,094,511.

Illustrative of other useful aramids are poly(m-xylylene adipamide), poly(p-xylylene sebacamide), poly 2,2,2-trimethylhexamethylene terephthalamide), poly(piperazine sebacamide), poly(metaphenylene isophthalamide) (Nomex.RTM.) and poly(p-phenylene terephthalamide) (Kevlar.RTM.); poly(1,4-benzamide), poly(chloro-1,4-phenylene terephthalamide), poly(1,4-phenylene fumaramide), poly(chloro-1,4-phenylene fumaramide), poly(4,4′-benzanilide trans, trans-muconamide), poly(1,4-phenylene mesaconamide), poly(1,4-phenylene) (trans-1,4-cyclohexylene amide), poly(chloro-1,4-phenylene) (trans-1,4-cyclohexylene amide), poly(1,4-phenylene 1,4-dimethyl-trans-1,4-cyclohexylene amide), poly(1,4-phenylene 2.5-pyridine amide), poly(chloro-1,4-phenylene 2.5-pyridine amide), poly(3,3′-dimethyl-4,4′-biphenylene 2.5 pyridine amide), poly(1,4-phenylene 4,4′-stilbene amide), poly(chloro-1,4-phenylene 4,4′-stilbene amide), poly(1,4-phenylene 4,4′-azobenzene amide), poly(4,4′-azobenzene 4,4′-azobenzene amide), poly(1,4′-phenylene 4,4′-azoxybenzene amide), poly(4,4′-azobenzene 4,4′-azoxybenzene amide), poly(1,4-cyclohexylene 4,4′-azobenzene amide), poly(4,4′-azobenzene terephthal amide), poly(3.8-phenanthridinone terephthal amide), poly(4,4′-biphenylene terephthal amide), poly(4,4′-biphenylene 4,4′-bibenzo amide), poly(1,4-phenylene 4,4′-bibenzo amide), poly(1,4-phenylene 4,4′-terephenylene amide), poly(1,4-phenylene 2,6-naphthal amide), poly(1,5-naphthylene terephthal amide), poly(3,3′-dimethyl-4,4-biphenylene terephthal amide), poly(3,3′-dimethoxy-4,4′-biphenylene terephthal amide), poly(3,3′-dimethoxy-4,4-biphenylene 4,4′-bibenzo amide) and the like; polyoxamides such as those derived from 2,2′dimethyl-4,4′diamino biphenyl and chloro-1,4-phenylene diamine; polyhydrazides such as poly chloroterephthalic hydrazide, 2,5-pyridine dicarboxylic acid hydrazide) poly(terephthalic hydrazide), poly(terephthalic-chloroterephthalic hydrazide) and the like; poly(amide-hydrazides) such as poly(terephthaloyl 1,4 amino-benzhydrazide) and those prepared from 4-amino-benzhydrazide, oxalic dihydrazide, terephthalic dihydrazide and para-aromatic diacid chlorides;

In the case of polyethylene, suitable fibbers are those of molecular weight of at least 150,000, especially at least 500,000, preferably at least one million and more preferably between two million and five million. Such extended chain polyethylene (ECPE) fibres may be grown in solution as described in U.S. Pat. No. 4,137,394 to Meihuzen et al., or U.S. Pat. No. 4,356,138 of Kavesh et al., issued Oct. 26, 1982, or a filament spun from a solution to form a gel structure, as described in German Off. 3,004,699 and GB 2051667, and especially described in application Ser. No. 572,607 of Kavesh et al., filed Jan. 20, 1984 (see EPA 64,167, published Nov. 10, 1982).

As used herein, the term polyethylene shall mean a predominantly linear polyethylene material that may contain minor amounts of chain branching or comonomers not exceeding 5 modifying units per 100 main chain carbon atoms, and that may also contain admixed therewith not more than about 50 wt % of one or more polymeric additives such as alkene-1-polymers, in particular low density polyethylene, polypropylene or polybutylene, copolymers containing mono-olefins as primary monomers, oxidised polyolefins, graft polyolefin copolymers and polyoxymethylenes, or low molecular weight additives such as anti-oxidants, lubricants, ultra-violet screening agents, colorants and the like which are commonly incorporated by reference. Depending upon the formation technique, the draw ratio and temperatures, and other conditions, a variety of properties can be imparted to these fibres.

Preferred polyethylene fibres are Dyneema produced by DSM High Performance Fibres BV Eisterweg 3 6422 PN Heerlen Netherlands and Spectra, produced by Honeywell Honeywell Performance Fibres Pole European de Development B.P. 16 548 10 Longlaville France.

It is also possible to use mixtures of all material mentioned herein, especially the polyethylenes and the polyamides.

Highly oriented polypropylene fibres of molecular weight about at least 200,000, especially about at least 750,000, preferably at least one million and more preferably at least two million may also be used. Such high molecular weight polypropylene may be formed into reasonably well oriented fibres by the techniques prescribed in the various references referred to above, and especially by the technique of U.S. Ser. No. 572,607 and of U.S. Ser. No. 259,266, and the continuations-in-part thereof. Polypropylene is a much less crystalline material than polyethylene and contains pendant methyl groups.

Polyamide prepared from the reaction of hexamethylene diamine and adipic acid (polyamide 6,6) is the preferred material in the article according to the invention.

The article is provided with a friction raising means. The friction raising means may be a finishing of the filaments, yarn or the woven fabric or cut parts of the fabric. The finishing material may be a binder, resin, glue or inorganic oxide that does not negatively affect the fabric. Useful glues and resins may be dimethylol-dihydroxy-ethyleneurea, N-methylol-dihydroxy-ethyleneurea, methylol-dihydroxy-ehtyleneurea, dimethylolurea.and melamine resins such as N-methoxymethylmelamin, methoxymethylmelamin, methylolmelamin, dimethoxymethylmelamin, butadiene styrol copolymer; acrylate styrol copolymer, acrylate ethylene vinyl acetate copolymer, polyacrylat, polyvinylacetat, ethylene vinyl acetate copolymer, acrylate ethylene vinylester copolymer.

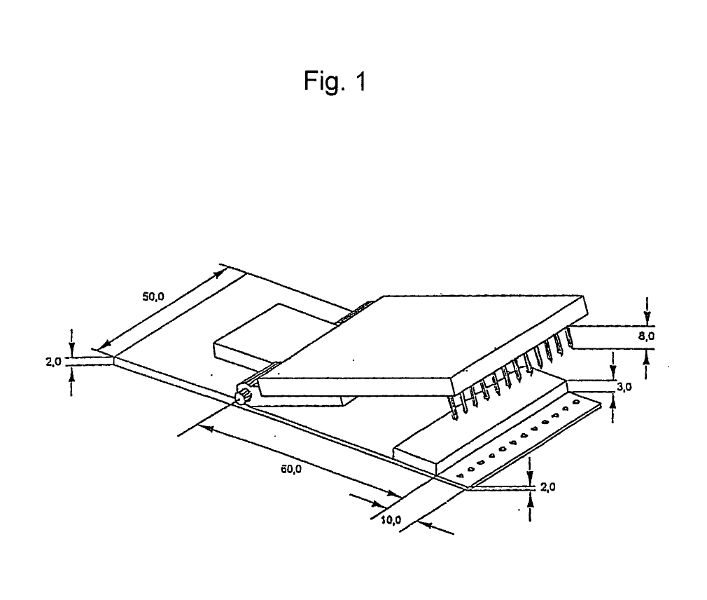

The increase of the friction depends on the closeness of the fabric and the finishing treatment. The increase of friction should preferably be at least 3% for the fabric produced according to Example 1. The friction increase may be tested according to ISO 13 934-1 using a specimen holder according to FIG. 1 (please see below).

Illustrative of useful friction raising compounds include inorganic salts and inorganic oxides that may form crystals on the finished fabric. Thus inorganic salts and oxides that are soluble or may be dispersed in water, water solutions or solutions that do not negatively affect the finished fabric may be used. Metal salts and metal oxides may be mentioned.

Useful substances are described in C. F. Liable, Ballistic Materials and Penetration Mechanics, Chapters 5-7 (1980) such as single oxides e.g. aluminium oxide (Al₂ O₃), barium oxide (BaO), beryllium oxide (BeO), calcium oxide (CaO), cerium oxide (Ce₂ O₃ and CeO₂), chromium oxide (Cr₂ O₃), dysprosium oxide (Dy₂ O₃), erbium oxide (Er₂ O₃), europium oxide: (EuO, Eu₂ O_{3,} and Eu₂ O₄), (Eu₁₆ O₂₁), gadolinium oxide (Gd₂ O₃), hafnium oxide (HfO₂), holmium oxide (Ho₂ O₃), lanthanum oxide (La₂ O₃), lutetium oxide (Lu₂ O₃), magnesium oxide (MgO), neodymium oxide (Nd₂ O₃), niobium oxide: (NbO, Nb₂ O_{3,} and NbO₂), (Nb₂ O₅), plutonium oxide: (PuO, Pu₂ O₃, and PuO₂), praseodymium oxide: (PrO₂, Pr₆ O₁₁, and Pr₂ O₃), promethium oxide (Pm₂ O₃), samarium oxide (SmO and Sm₂ O₃), scandium oxide (Sc₂ O₃), silicon dioxide (SiO₂), strontium oxide (SrO), tantalum oxide (Ta₂ O₅), terbium oxide (Tb₂ O₃ and Tb₄ O₇), thorium oxide (ThO₂), thulium oxide (Tm₂ O₃), titanium oxide: (TiO, Ti₂ O₃, Ti₃ O₅ and TiO₂), uranium oxide (UO₂, U₃ O₈ and UO₃), vanadium oxide (VO, V₂ O₃, VO₂ and V₂ O₅), ytterbium oxide (Yb₂ O₃), yttrium oxide (Y₂ O₃), and zirconium oxide (ZrO₂). Useful ceramic materials also include boron carbide, zirconium carbide, beryllium carbide, aluminium carbide, boron carbide, silicon carbide, titanium nitride, boron nitride, titanium carbide, titanium diboride, iron carbide, iron nitride, barium titanate, aluminium nitride, titanium niobate, boron carbide, silicon boride, barium titanate, silicon nitride, calcium titanate, tantalum carbide, graphites, tungsten; the ceramic alloys which include cordierite/MAS, lead zirconate titanate/PLZT, alumina-titanium carbide, alumina-zirconia, zirconia-cordierite/ZrMAS; the fibre reinforced ceramics and ceramic alloys; glassy ceramics; as well as other useful materials.

Preferably silicon compounds are used e.g. silica (silicic acid, silicon oxide), modified silica, silica esters, a composition comprising silicon compounds, silica, silica resins, dispersion of silica, colloidal silicic acid, colloidal polysilicic acid, modified colloidal silicic acid and modified colloidal polysilicic acid.

Also mixtures of a resin and/or a glue and/or friction raising compound e.g. an inorganic oxide may be used. Silica is preferred as it gives both a binding and friction raising effect.

The friction raising means is preferably applied over the whole area of the layers. Thus a friction raising substance is preferably soaked into all the material so that it covers both the yarn and a part of or the whole of the intervening spaces in order to prevent a penetration article to come through.

The friction raising substance may be sprayed, coated, printed or in any other way applied on to the filaments or yarn before weaving or preferably on to the woven fabric. Threads or yarn for use in warp and/or weft may be treated. The substance may be applied to one or preferably both sides of the fabric or be soaked into the material. The fabric may also be dipped into a mixture, solution or dispersion comprising the resin, glue or inorganic salt or oxide that does not negatively affect the fabric. It is also possible to treat a single layer or a bunch of layers as described above for the treatment of the fabric. Preferably the fabric is dipped into a solution or a slurry of silica, such as a water solution containing 1-250 g/silica, preferably 30-120 g silica/l, especially 80g/l silica. Syntharesin S50 (article 01509911, from Bayer AB Box 5237, SE 402 24 Gothenburg, Sweden) is preferred.

After treatment with the friction raising means a heat treatment or curing of the friction raising means is performed.

The protective article according to the invention is still very flexible and very usable when mainly ice pick threats are at hand. Thus, the stiffness of the fabric layer is preferably less than 50N, preferably less than 35N and e.g. between 15 and 30N, preferably between 18 and 30N, measured according to ASTM D 4032. The article can be used for protection against any sharp article, such as non cutting articles e.g. ice picks, needles and cannulas, etc. and not only in the form of threats man against man.

The article according to the invention may be used in a method for protection against stabs where article is provided as such or in combination with other knife and ballistic resistant layers in a protective garment.

The invention will now be described with reference to the accompanying figure:

FIG. 1, which describes a Specimens holder for the Comp Stripping Test. The dimensions are 50.0 mm total width for base plate of the specimens holder; 70.0 mm total length for moveable arm of the specimens holder; 3.0 mm distance from centre of the first needle to edge of specimens holder; 4.0 mm distance between centres of the needles; 1.0 mm diameter of needles; 12 grounded needles; 8.0 mm length of visible needles; 10.0 mm total lock distance for specimens; 5.0 mm distance between centre of drillings to edge of specimen holder; 1.5 mm diameter of drillings at the base plate; connection between specimens holder and testing device to be fitted due to the needs of the testing device.

All publications cited in this description are hereby incorporated by reference. The invention will now be described with the following non-limiting examples.

### EXAMPLE 1

A woven fabric with a length of 300 m and a width of 182 cm was produced from a Polyamid 6.6 yarn from Acordis type 446 HRT having a linear density of 350 dTex, with 140 filaments in warp and weft (Acordis Industrial Fibres GmbH & CO. KG Kasinostasse 19-21, D-42097 Wuppertal Germany). The construction was 1/1 plain and the finished fabric set 27 threads/cm in warp and 26 threads/cm in weft.

The fabric was washed with a wash solution comprising 50 ml/l NaOH, 40 ml/l Lavotan DSU (25-50% etoxylated oxoalcohol C13, 69011-36-5, Xi; R 36/38, 10-25% 2-metylpentan-2,4-diol, 107-41-5, Xi; 36/38, 2,5-5% etoxylated oxoalcohol C13, 69011-36-5, Xi, N; R 36/38-51/53, 2,5-5% alkane (C14/C16)sulphonic acid sodium salt 68439-57-6, Xi; R 36/38 from Nils Holmberg AB, Tämta Kil 31, S-51393 Fristad, Sweden), 8 ml/l Heptol NWS (polyacrylic acid, sodium salt in water dispersion containing polyphosphate from Nils Holmberg AB as above). The washing was performed at 95° C. The fabric was then rinsed in water. The washing and rinsing are performed in a bath with a length of 17 m comprising several rollers arranged so that 95 m is in the washing zone and 55 m is in the rinsing zone. The fabric is moved at a speed of 50 m/min.

Hereafter the fabric is dried at 130° C. at a speed of 44 m/min in an oven with a length of 24 m.

After drying the woven fabric was moved from a roller at a rate of 44 m/min through a finishing line comprising, two baths containing finishing solutions, a pair of press rollers, several directing rollers and an oven. Finally the fabric was chilled on two chilling rollers with a feeding roller in between. The finishing baths consisted of silica Syntharesin S50 at a concentration of 80 g/l in tap water. The oven had a temperature of 130° C. and a length of 24 m. The dwell time in the oven was 35 s. The weight of the fabric increased with 1%.Data on the fabric is summarised in table 1.

TABLE 1

| | | | | | Result | | | | | | |
|---|---|---|---|---|---|---|---|---|---|---|---|
| CC | Method | Parameter | Spec | Unit | Sample 1 | Sample 2 | Sample 3 | Sample 4 | Sample 5 | Sample 6 | Average |
| | | Thread | | | | | | | | | PA 6.6 446 HRT |
| | | Titer/filaments | | dTex/No | | | | | | | 350 dTex f 140 |
| | | Twist | | T/m | | | | | | | 0 |
| | | Construction | | | | | | | | | 1/1 Plain |
| | | Linear Density | Warp | Ends/dm | 270 | 275 | 275 | 275 | 275 | | 274 |
| | | | Weft | Picks/dm | 260 | 255 | 260 | 260 | 265 | | 260 |
| | ISO 5084 | Thickness | | mm | 0.34 | 0.34 | 0.33 | 0.33 | 0.33 | | 0.33 |
| | | Useable Width | | cm | 180 | 179.5 | 180 | 180 | 179.5 | | 180 |
| | EN 12 127 | Weight Fabric | | g/m² | 220 | 220 | 221 | 221 | 219 | | 220 |
| | ISO 13 934-1 | Tensile Strength | Warp | N/5 cm | 3285 | 3354 | 3482 | 3412 | 3363 | | 3379 |
| | | | Weft | N/5 cm | 3507 | 3641 | 3513 | 3603 | 3627 | | 3578 |
| | ISO 13 934-1 | Elongation at | Warp | % | 39 | 41 | 39 | 39 | 39 | | 39 |
| | | Break | Weft | % | 28 | 29 | 28 | 29 | 30 | | 29 |
| | ISO 13 937-2 | Tear Strength | Warp | N | 95 | 96 | 97 | 98 | 99 | | 97 |
| | | | Weft | N | 99 | 105 | 106 | 104 | 98 | | 102 |
| | ISO 13 934-1 | Comb Stripping | Warp | N | 1139 | 972 | 1114 | 1117 | 1091 | | 1087 |
| | | 12 needle | Weft | N | 1129 | 1044 | 1148 | 1042 | 1031 | | 1079 |
| | FMV SS 302 | Flammability | Warp | mm/min | SE/NBR | SE/NBR | SE/NBR | SE/NBR | SE/NBR | | SE/NBR |
| | | | Weft | mm/min | SE/NBR | SE/BR 11 | SE/BR 13 | SE/NBR | SE/BR 19 | | SE/BR 19 |
| | ASTM D 4032 | Stiffness | | N | 18.8 | 20.3 | 27.6 | 20.1 | 19.6 | | 21.3 |
| | ISO 9237 | Air Permeability | | l/dm²/min | 1.57 | 1.46 | 1.38 | 1.41 | 1.36 | | 1.44 |

### EXAMPLE 2

Example 1 was repeated with polyamide 66, type 769 470 dTex 136 filament from DuPont with 21,5 threads/cm in warp and 23 threads/cm in weft.

### EXAMPLE 3

Example 1 was repeated with polyamide 66, type 444 HRST 470 dTex 72 filaments from Acordis with 23 threads/cm in warp and 21 threads/cm in weft.

### EXAMPLE 4

Example 1 was repeated with polyamide 66, type 769 700 dTex 210 filaments from DuPont with 18 threads/cm in warp and 18 threads/cm in weft.

Stab Resistance Drop Test.

16 layers of the fabric produced according to Example 1 were put together and tested according to the Stab Resistance Drop Test of Personal Body Armor, NIJ Standard 0115.00 (National Law Enforcement and Correction Technology Center, P.O. Box 1160, Rockville, Md. 20849-1160, USA E-Mail: asknlectc@nlectc.org, World Wide Web address: http://www.nlectc.org).

Four tests were made with each 16 layers. For Protection level 1 where the strike energy is 24 J at impact angles of incidence of 0° and 45°. The tested products did not allow a spike penetration at all. According to the test the body armor shall not allow a spike penetration greater than 7 mm from any fair strike for 24 J strike energies at impact angles of incidence of 0° and 45°.

Four tests were then made with each 16 layers under the overtest condition where the strike energy is 36 J at impact angles of incidence of 0° and 45°. The tested products did allow a spike penetration of 9, 11, 14 and 15 mm respectively. According to the test the body armor shall not allow a spike penetration greater than 20 mm from any fair strike for 36 J strike energies at impact angles of incidence of 0° and 45°.

The ice pick gets stuck in the fabric showing the very firm ice pick resistance in the finished fabric.

Friction Test.

The fabric produced in Example 1was friction tested before and after applying the silica finishing in order to estimate the increase of friction of the fabric surface. These tests were performed according to ISO 13 934-1.

Briefly the comb stripping is measured on a peace of fabric, length 25-35 cm, width 5 cm. The fabric is fastened in a specimens holder according to FIG. 1, holding the fabric with 12 needles 5 mm from the edge of the fabric.

The friction force increased by 5% after finishing with silica. Also, the number of treated layers needed to fulfil the NIJ requirements were lowered by 30% by applying the silica finishing compared to untreated layers.

1. A penetration resistant article consisting essentially of one or more layers of a woven fabric made from a yarn of polyester, polyamide, polypropylene, polyethylene, or derivatives or mixtures thereof and having a friction raising means.

2. A penetration resistant article according to claim 1, which is less penetrated than 7 mm at 24 joules and less than 20 mm at 36 joules when tested according to NIJ Standard 0115.00.

3. A penetration resistant article according to claim 1, wherein at least two layers of the fabric are included in the article.

4. A penetration resistant article according to claim 1, wherein the linear density is less than 1800 dTex.

5. A penetration resistant article according to claim 4, wherein the linear density is 100 dTex -1800 dTex.

6. A penetration resistant article according to claim 1, wherein the yarn has 15-250 filaments in warp and weft.

7. A penetration resistant article according to claim 6, wherein the yarn has 15-150 filaments in warp and weft.

8. A penetration resistant article according to claim 1, wherein the closeness of the fabric is 10-60 threads/cm in warp and weft.

9. A penetration resistant article according to claim 8, wherein the closeness of the fabric is 15-40 threads/cm in warp and weft.

10. A penetration resistant article according to claim 9, wherein the closeness of the fabric is 25-35 threads/cm in warp and weft.

11. A penetration resistant article according to claim 1, wherein said means is a binder, resin, glue, inorganic salts or inorganic oxides or any mixture thereof.

12. A penetration resistant article of claim 11, wherein said means is silica or a composition comprising a silicon compound.

13. A penetration resistant article according to claim 1, wherein the yarn is made of nylon 6.6.

14. A penetration resistant article according to claim 1, wherein the yarn is made of polyethylene or polyethylene naphtalate.

15. A penetration resistant article according to claim 1, wherein the article has been provided with friction raising means by dipping the fabric in a water solution comprising 1-250 g silica/l, preferably 30-120 g silica/l.

16. A penetration resistant article according to claim 1, wherein the article has been provided with friction raising means by dipping the fabric in a water solution comprising 30-120 g silica/l.

17. A penetration resistant article according to claim 1, wherein the article after being provided with said friction raising means has been dried or cured.

18. A penetration resistant article according to claim 1, wherein said friction raising means acts as a binder to the yarns or threads of said woven fabric.

19. A penetration resistant article according to claim 1, wherein said layers are more than 10.
